(19) United States
(12) Patent Application Publication
(10) Pub. No.: US 2007/0048500 A1
(43) Pub. Date: Mar. 1, 2007

(54) Blade of a venetian blind

(76) Inventor: Cheng-Hsien Tseng, Taichung City (TW)

Correspondence Address: COOPER & DUNHAM, LLP, 1185 AVENUE OF THE AMERICAS, NEW YORK, NY, 10036, US

(21) Appl. No.: 11/215,689

(22) Filed: Aug. 30, 2005

(51) Int. Cl. B32B 3/00

(52) U.S. Cl. 428/172; 428/141

(57) ABSTRACT

A blade of a venetian blind has a flat metallic body, two pattern layers and two outer coating layers. The flat metallic body has two sides. The pattern layers are coated respectively to the sides of the flat metallic body. The outer coating layers are see-through and coated respectively to the pattern layers to form rough surfaces on the blade. With the arrangement of the outer coating layers, the blade has an aesthetic appearance and is versatile in use.

### BACKGROUND OF THE INVENTION

1. Field of the Invention

The present invention relates to a blade, and more particularly to a blade of a venetian blind and having a glistening-proof effect and an aesthetic appearance.

2. Description of Related Art

A venetian blind is mounted on a window of a house to block light from entering into the house and substantially comprises multiple blades connected with each other with multiple cords. The conventional blade of the conventional venetian blind is always made of aluminum to reduce the weight of the whole venetian blind and to provide a fireproof effect, and the conventional metallic blade is friendly to the environment. With reference to FIG. 5, a conventional blade (50) of a venetian blind comprises a flat metallic body (51) and two pattern layers (52). The pattern layers (52) are coated respectively to two sides of the flat metallic body (51) by adhesive papers and each has a print pattern or figure to improve the appearance of the blade (50).

However, the pattern layers (52) of the conventional blade (50) have a smooth surface and easy glisten, such that the patterns on the pattern layers (52) are influenced by glistening and the appearance of the conventional blade (50) is not aesthetic. In addition, the blade (50) has only a single light-blocking function and is not versatile in use.

To overcome the shortcomings, the present invention tends to provide a blade of a venetian blind to mitigate or obviate the aforementioned problems.

### SUMMARY OF THE INVENTION

The main objective of the invention is to provide a blade of a venetian blind and that has an aesthetic appearance and is versatile in use. The blade has a flat metallic body, two pattern layers and two outer coating layers. The flat metallic body has two sides. The pattern layers are coated respectively to the sides of the flat metallic body. The outer coating layers are see-through and coated respectively to the pattern layers to form rough surfaces on the blade.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a blade in accordance with the present invention;

FIG. 2 is a cross sectional side plan view of the blade in FIG. 1;

FIG. 3 is another cross sectional side plan view of the blade in FIG. 1;

FIG. 4 is a schematic diagram of a device for coating outer coating layer onto the flat metallic body with pattern layers of the blade in FIG. 1; and

FIG. 5 is a cross sectional side plan view of a conventional blade of a venetian blind in accordance with the prior art.

### DETAILED DESCRIPTION OF PREFERRED EMBODIMENT

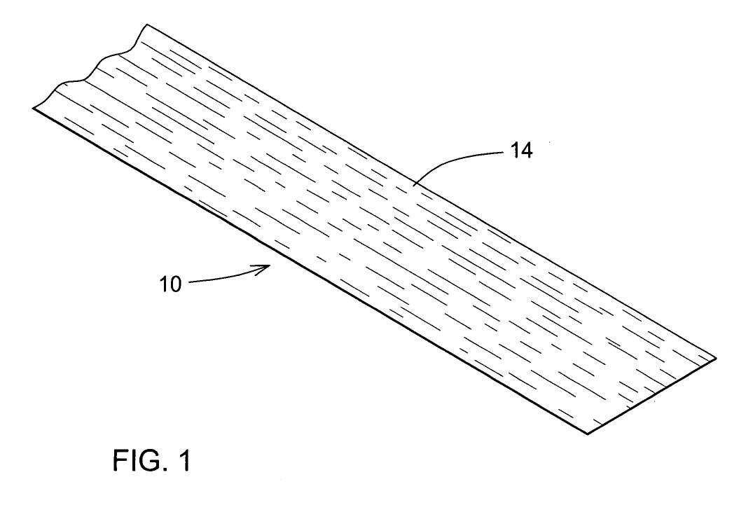

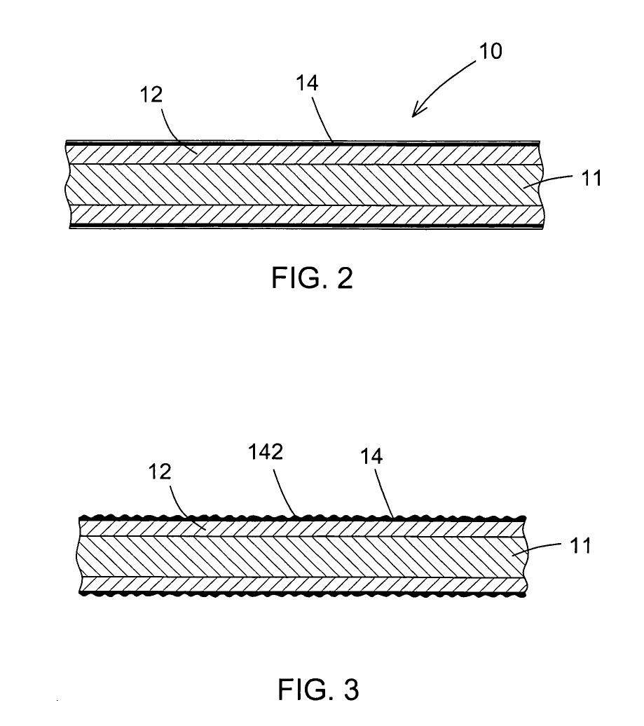

With reference to FIGS. 1 to 3, a blade (10) of a venetian blind in accordance with the present invention comprises a flat metallic body (11), two pattern layers (12) and two outer coating layers (14). The flat metallic body (11) may be made of aluminum alley and has two sides. The pattern layers (12) are coated respectively to the sides of the flat metallic body (11) by adhesive papers and each has a print pattern or figure.

The outer coating layers (14) are coated respectively to the pattern layers (12), are made of see-through material and may be ultraviolet coatings (U.V. coatings). Each outer coating layer (14) has multiple protruding patterns (142) formed on the outer coating layer (14).

With the arrangement of the see-through outer coating layers (14), rough surfaces are formed on the blade (10) by the outer coating layers (14) with protruding patterns (142) and an anti-glistening effect is provided. With experiments of the inventor of the present invention, about 15 to 40% of glistening on the surfaces of the blade (10) can be reduced, such that the patterns on the pattern layers (142) can be shown clearly and the appearance of the blade (10) is improved. In addition, the protruding patterns (142) on the outer coating layers (14) can provided a three-dimensional visional effect to make the appearance of the blade (10) aesthetic. Furthermore, because the outer coating layers (14) can be U.V. coating, such that an anti-ultraviolet effect is provided to the blade (10) and the blade (10) is versatile in use.

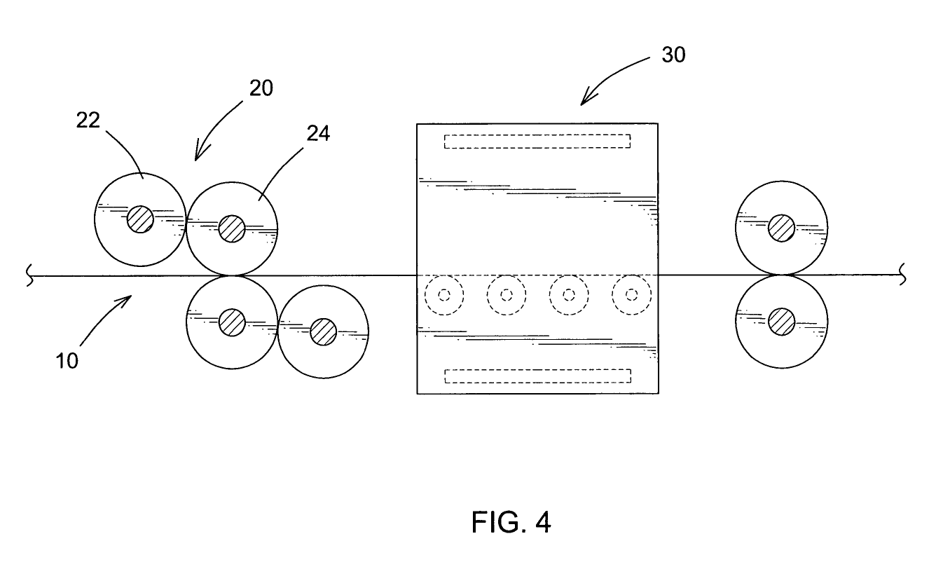

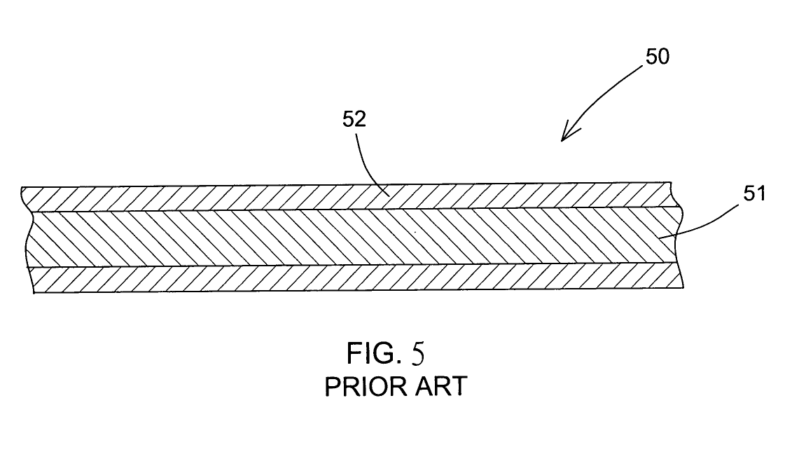

With further reference to FIG. 4, to coat the outer coating layers (14) with protruding patterns (142) onto the pattern layers (12) on the flat metallic body (11), a coating device is used. The coating device comprises a coating wheel assembly and a dryer (30). The coating wheel assembly comprises two wheel sets (20). Each wheel set (20) comprises a steel wheel (22) and a coating wheel (24), and the coating wheels (24) of the wheel sets (20) align with each other. Each steel wheel (22) has an outer surface provided with multiple protrusions and grooves. Each coating wheel (24) is made of a resilient material, such as rubber, and has an outer surface abutting with the outer surface of a corresponding steel wheel (22). The dryer (30) may comprise two ultraviolet lamps.

In operation, the flat metallic body (11) coated with the pattern layers (12) is conveyed to the coating device, and the coating wheels (24) of the wheel sets (20) abut respectively with two sides of the semi-finished blade (10). Coating material is applied to and coated on the outer surfaces of the steel wheels (22). With the arrangements of the protrusions and grooves on the steel wheels (22), the coating material will be transferred to the outer surfaces of the coating wheels (24) in a form with multiple protruding patterns. Then, the coating material with multiple protruding patterns is coated to the sides of the semi-finished blade (10) with the coating wheels (24). After the dryer (30) drying the coating material, outer coating layers (14) with multiple protruding patterns (142) are formed on the blade (10). In addition, with the arrangement of the ultraviolet lamps, an anti-ultraviolet effect can be applied to the outer coating layers (14).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A blade of a venetian blind comprising:
a flat metallic body having two sides;
two pattern layers coated respectively to the sides of the flat metallic body; and
two see-through outer coating layers coated respectively to the pattern layers to form rough surfaces on the blade.

2. The scissors as claimed in claim 1, wherein each outer coating layer has multiple protruding patterns formed on the outer coating layer.
